(19) United States
(12) Patent Application Publication
(10) Pub. No.: US 2024/0229868 A1
(43) Pub. Date: Jul. 11, 2024

(54) CLAMPING RING AND BEARING UNIT COMPRISING THE RING

(71) Applicant: NTN CORPORATION, Osaka (JP)

(72) Inventor: Mitsuhiko YOSHIKAWA, Mie (JP)

(21) Appl. No.: 18/403,126

(22) Filed: Jan. 3, 2024

(30) Foreign Application Priority Data
Jan. 10, 2023 (JP) 2023-001675

(51) Int. Cl. F16C 35/063

(52) U.S. Cl. CPC F16C 35/063; F16C 2226/10

(57) ABSTRACT

A clamping ring (6) includes: a ring main body (10) including a cut (13) formed in a part in a circumferential direction and a pair of circumferential-direction end portions (14a and 14b) opposed to each other across the cut (13); and bolt holes (11a and 11b) passing through the pair of circumferential-direction end portions (14a and 14b). The clamping ring (6) further includes a misalignment preventing part (16) configured to prevent misalignment of a center of gravity (CG) of the ring main body (10) from a center line (C1) of an inner peripheral surface (10a) of the ring main body (10).

### BACKGROUND OF THE INVENTION

### 1. Field of the Invention

The present invention relates to a clamping ring and a bearing unit comprising the ring, more particularly, to a structure of a clamping ring that can be reduced in diameter by tightening a bolt.

### 2. Description of the Related Art

There exists a ring-shaped member referred to as “set collar” as a mechanical element. For use, this member is mainly mounted over a rotary shaft and serves to fix a position of a bearing, a pulley, or the like in an axial direction (see, for example, Japanese Patent Application Laid-open No. 2010-110370).

Meanwhile, this kind of collar is also used to fix an inner ring of a rolling bearing such as a ball bearing onto a shaft in some cases. In this case, for example, the inner ring of the bearing is formed to have an axial-direction extending part, and a ring-shaped set collar is mounted over an outer periphery of the extending part. Then, a bolt is inserted into bolt holes and is then tightened. The bolt holes are formed in two circumferential-direction end portions of the set collar, which are opposed to each other across a cut. As a result of the tightening, the set collar is reduced in diameter. Thus, the axial-direction extending part of the inner ring, which is located on an inner periphery of the set collar, is pressed against the shaft to thereby fix the inner ring onto the shaft (see, for example, Japanese Patent Application Laid-open No. 2006-46505).

The above-mentioned fixing structure for the bearing with use of the set collar has an advantage in that misalignment between a center of the bearing and a center of the set collar is less liable to be caused at the time of mounting as compared with a fixing structure using, for example, a set screw, an adapter, or an eccentric collar. This advantage is provided by an action of tightening the axial-direction extending part of the inner ring from an outer periphery thereof by reducing a collar main body having a ring shape in diameter. Further, the fixing structure using the set collar described above enables fixing only by inserting (tightening) the bolt through the bolt holes formed in one location of the collar main body in a circumferential direction. Thus, the above-mentioned fixing structure has another advantage in a smaller number of mounting steps in comparison to other fixing structures.

Meanwhile, this kind of member typically has a so-called C-ring shape with a cut in a part of the collar main body having a ring shape in the circumferential direction. The member has a structure with bolt holes formed in a pair of circumferential-direction end portions of the collar main body, which are opposed to each other across the cut. Thus, a center of gravity of the set collar is more liable to be shifted in a radial direction toward the side opposite to the side with the bolt holes from a center of an inner peripheral surface of the collar main body, on which the center of gravity should otherwise be located. This may cause misalignment of a center of gravity of a rotary body including the set collar from a center of the rotary body. As a result, a non-negligible degree of whirling may occur, preventing required rotation performance from being achieved.

### SUMMARY OF THE INVENTION

In view of the actual circumstances described above, a technical problem to be solved by the present invention is to prevent misalignment of a center of gravity of a clamping ring that can be reduced in diameter by tightening a bolt so as to suppress whirling of a shaft to which an inner ring of a bearing is fixed with use of the clamping ring.

A solution for the problem described above is achieved by a clamping ring according to the present invention. That is, this ring is a clamping ring for fixing a part of an inner ring of a bearing through a diameter-reducing action to a shaft part by tightening the part of the inner ring from an outer periphery thereof, the clamping ring comprising: a ring main body comprising a cut formed in a part in a circumferential direction and a pair of circumferential-direction end portions opposed to each other across the cut; bolt holes passing through the pair of circumferential-direction end portions, the bolt holes allowing a bolt to be inserted therethrough and then tightened to reduce the ring main body in diameter; and a misalignment preventing part configured to prevent misalignment of a center of gravity of the ring main body from a center line of an inner peripheral surface of the ring main body.

The clamping ring having the configuration described above allows the following actions and effects to be enjoyed. Specifically, when the inner ring of the bearing is fixed to the shaft part with use of the clamping ring having the configuration described above, the clamping ring is arranged on an outer periphery of an axial-direction extending part being a part of the inner ring. Then, the bolt is inserted into the bolt holes formed in the two circumferential-direction end portions of the ring main body, which are opposed to each other across the cut, and is then tightened. Thus, the ring main body is deformed in a direction in which the pair of circumferential direction-end portions, each having the bolt hole, are brought closer to each other. Hence, a diameter defined by the inner peripheral surface of the ring main body is reduced. As a result, the axial-direction extending part of the inner ring is pressed radially inward by the ring main body. Thus, for example, when the axial-direction extending part has a plurality of claw portions extending in an axial direction, the plurality of claw portions are deformed radially inward and are pressed against the shaft part. As a result, the inner ring is fixed onto the shaft part. At this time, the inner peripheral surface of the ring main body is in close contact with the axial-direction extending part of the inner ring. Thus, when the center line of the inner peripheral surface of the ring main body and a center line of an inner peripheral surface of the inner ring are aligned with each other, the center of gravity of the clamping ring is aligned with or is extremely close to the center line of the inner peripheral surface of the ring main body, specifically, the center line of the inner peripheral surface of the inner ring. Hence, when the inner ring is mounted over the shaft part, whirling, which may occur during rotation, can be prevented as much as possible to enable achievement of excellent rotation performance.

Further, in the clamping ring according to the present invention, the misalignment preventing part may be achieved by setting a center line of an outer peripheral surface of the ring main body and the center line of the inner peripheral surface at different positions.

The ring main body has a ring shape. Thus, a thickness of the ring main body in a radial direction is determined by sizes of the inner peripheral surface and an outer peripheral surface of the ring main body and a positional relationship between the inner peripheral surface and the outer peripheral surface. When a position of the outer peripheral surface is determined with respect to a position of the inner peripheral surface so that a center line of the outer peripheral surface and the center line of the inner peripheral surface are aligned with each other, the thickness of the ring main body in the radial direction is the same. Thus, when the misalignment preventing part is achieved by setting the center line of the outer peripheral surface of the ring main body at a position different from a position of the center line of the inner peripheral surface as described above, the thickness of the ring main body in the radial direction has a difference (distribution). For example, when the center line of the outer peripheral surface is shifted toward the bolt holes, a thickness distribution in which the side with the bolt holes has a relatively large thickness and the side opposite to the bolt holes across the center line of the inner peripheral surface has a relatively small thickness is obtained as a whole. Thus, a lack of weight in a part on the side with the bolt holes is compensated for by setting the thickness of the part larger so that the center of gravity of the clamping ring is aligned with or set as close as possible to the center line of the inner peripheral surface of the ring main body and, in turn, the center line of the inner peripheral surface of the inner ring. Further, when the center line of the outer peripheral surface is to be set at a position different from a position of the center line of the inner peripheral surface, a process condition is only required to be coordinated at the time when a traditional process such as finishing for the outer peripheral surface is performed. Thus, the number of steps can be prevented from being substantially increased to allow production costs to be maintained.

Further, in the clamping ring according to the present invention, the misalignment preventing part may comprise one or a plurality of holes passing through the ring main body.

As described above, also when the misalignment preventing part comprises one or a plurality of holes passing through the ring main body, weight balance of the ring main body can be adjusted. More specifically, when, for example, a hole passing through the ring main body in the radial direction is formed in the ring main body on the side that is opposite to the bolt holes across the center line of the inner peripheral surface of the ring main body in consideration of positions of the bolt holes in a circumferential direction, the center of gravity of the ring main body can be aligned with or set as close as possible to the center line of by the inner peripheral surface of the ring main body. Thus, when, for example, there arises a need for adjustment of the weight balance of the ring main body after the start of production, the center of gravity of the clamping ring can easily be aligned with the center line of the inner peripheral surface of the ring and, in turn, the center line of the inner peripheral surface of the inner ring by simply adding a hole formation process for the through hole described above.

Further, in the clamping ring according to the present invention, the misalignment preventing part may comprise a setback portion formed by setting inward a part of an outer peripheral surface of the ring main body toward a center line of the outer peripheral surface.

As described above, also when the misalignment preventing part comprises the setback portion formed by setting inward a part of the outer peripheral surface of the ring main body toward the center line of the outer peripheral surface, the weight balance of the ring main body can be adjusted. More specifically, when, for example, the setback portion is formed on the outer peripheral surface of the ring main body on the side opposite to the bolt holes across the center line of the inner peripheral surface, the center of gravity of the ring main body can be aligned with or set closer to the center line of the inner peripheral surface. Further, also when the clamping ring has the configuration described above, the center of gravity of the clamping ring can easily be aligned with the center line of the inner peripheral surface of the ring main body and, in turn, the center line of the inner peripheral surface of the inner ring by simply adding a predetermined process for the outer peripheral surface of the ring main body after the start of production.

Further, in the clamping ring according to the present invention, the misalignment preventing part may be set based on the center of gravity of the ring main body under a state in which the bolt is mounted into the bolt holes.

The ring main body corresponds to a large part of the clamping ring. Thus, the misalignment preventing part may be set regarding a center of gravity of the ring main body as the center of gravity of the clamping ring. Meanwhile, it is considered that weight of the bolt to be mounted into the bolt holes of the ring main body may considerably affect the position of the center of gravity of the clamping ring. Thus, when the weight of the bolt is taken into consideration, it is preferred that the misalignment preventing part be set based on the center of gravity of the ring main body under a state in which the bolt is mounted in the bolt holes of the ring main body. In this manner, the center of gravity of the clamping ring can more precisely be aligned with the center line of the inner peripheral surface of the ring main body, that is, the center line of the inner peripheral surface of the inner ring. Thus, whirling, which may occur during rotation, can more reliably be prevented to enable achievement of further excellent rotation performance.

Further, the clamping ring described above prevents misalignment of the center of gravity of the clamping ring that can be reduced in diameter by tightening a bolt so as to suppress whirling of the shaft onto which the inner ring of the bearing is fixed with use of the clamping ring. Thus, a bearing unit comprising, for example, the clamping ring having the configuration described above, the bolt to be mounted into the bolt holes of the clamping ring, the inner ring, the shaft part to be fitted on the inner periphery of the inner ring, and the outer ring being rotatable relative to the inner ring can be suitably provided.

As described above, according to the present invention, the whirling of the shaft onto which the inner ring of the bearing is fixed with use of the clamping ring can be suppressed by preventing the misalignment of the center of gravity of the clamping ring that can be reduced in diameter by tightening the bolt. Thus, rotation accuracy can be improved.

### BRIEF DESCRIPTION OF THE DRAWINGS

FIG. 1 is a sectional view of a bearing unit comprising a clamping ring according to a first embodiment of the present invention, taken along an imaginary cross section containing a center line of the bearing unit.

FIG. 2 is a sectional view of the bearing unit illustrated in FIG. 1, taken along the line A-A.

FIG. 3 is a perspective view of the clamping ring illustrated in FIG. 1.

FIG. 4 is a front view of the clamping ring illustrated in FIG. 1.

FIG. 5 is a front view of a clamping ring according to a second embodiment of the present invention.

FIG. 6 is a front view of a clamping ring according to a third embodiment of the present invention.

FIG. 7 is a front view of a clamping ring according to a fourth embodiment of the present invention.

FIG. 8 is a front view of a clamping ring to be compared with the clamping ring according to the present invention.

### DESCRIPTION OF THE EMBODIMENTS

Now, with reference to the drawings, description is made of a first embodiment of the present invention.

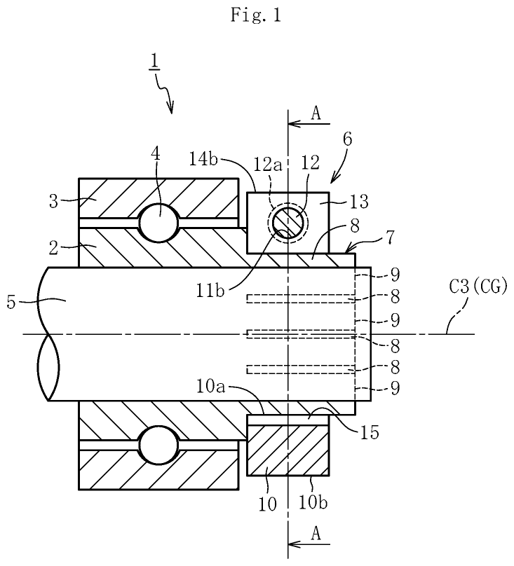

FIG. 1 is a sectional view of a bearing unit 1 comprising a clamping ring according to this embodiment. The bearing unit 1 comprises an inner ring 2, an outer ring 3, rolling elements 4, a shaft part 5, and a clamping ring 6.

In this embodiment, the bearing unit 1 comprises a ball bearing corresponding to a rolling bearing. More specifically, a plurality of rolling elements 4 (balls in this embodiment) are disposed between the inner ring 2 and the outer ring 3. The outer ring 3 is disposed on an outer periphery of the inner ring 2. Rolling of the plurality of rolling elements 4 with respect to the inner ring 2 and the outer ring 3 enables smooth rotation of the inner ring 2 relative to the outer ring 3.

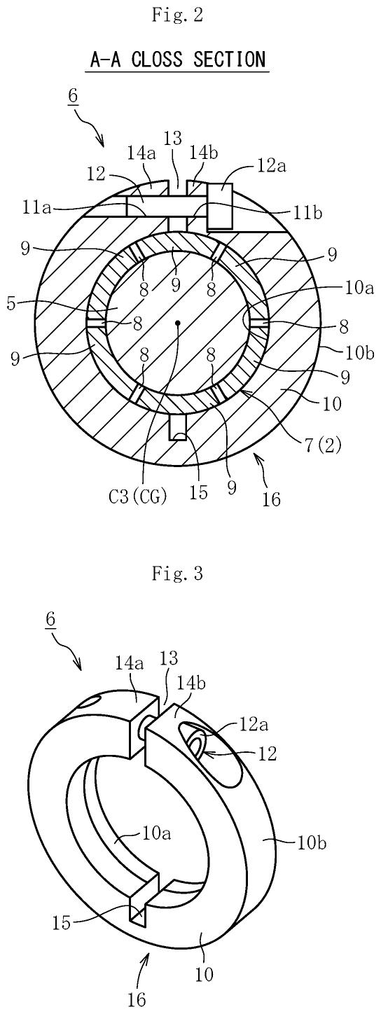

The shaft part 5 is fitted on an inner periphery of the inner ring 2. When an axial-direction extending part 7 of the inner ring 2 is pressed radially inward by the clamping ring 6 described later, the inner ring 2 is fixed onto the shaft part 5. In this case, the axial-direction extending part 7 of the inner ring 2 has a cylindrical shape as a whole (see FIG. 2) and has a structure comprising a plurality of claw portions 9 separated from each other by slits 8 extending in an axial direction. In this case, the clamping ring 6 is disposed on an outer periphery of the axial-direction extending part 7, and the shaft part 5 is inserted along the inner periphery of the inner ring 2. Under this state, the plurality of claw portions 9 of the axial-direction extending part 7 are pressed and deformed radially inward through a diameter-reducing action for the clamping ring 6. As a result, the plurality of claw portions 9 are pressed against an outer peripheral surface of the shaft part 5. Thus, the inner ring 2 is fixed onto the shaft part 5 through intermediation of the claw portions 9, enabling the inner ring 2 and the shaft part 5 to rotate integrally.

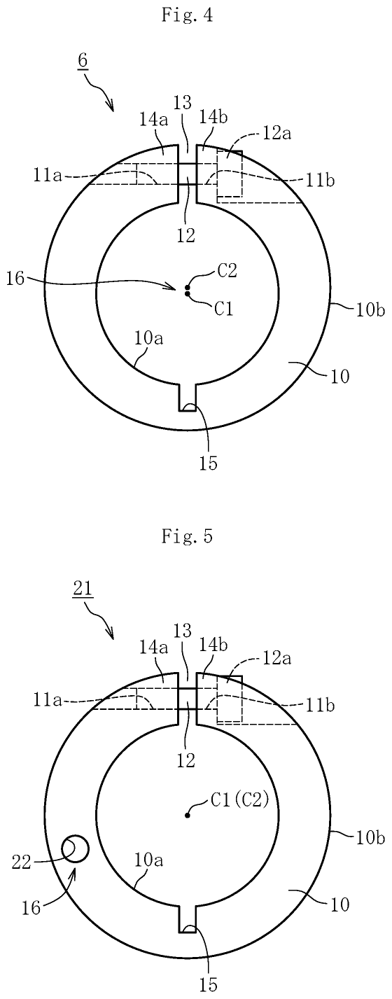

FIG. 3 is a perspective view of the clamping ring 6 according to this embodiment, and FIG. 4 is a front view of the clamping ring 6. As illustrated in FIG. 3 and FIG. 4, the clamping ring 6 comprises a ring main body 10, bolt holes 11a and 11b, and a bolt 12.

A cut 13 is formed in a part of the ring main body 10 in a circumferential direction. The cut 13 defines a pair of circumferential-direction end portions 14a and 14b of the ring main body 10 that are opposed to each other across the cut 13. In this case, the bolt holes 11a and 11b are formed so as to pass through the pair of circumferential-direction end portions 14a and 14b along a common imaginary straight line. Thus, the bolt 12 is inserted from one bolt hole 11b into another bolt hole 11a and is then turned in a predetermined direction to be tightened. As a result, a fitting length between a female thread portion (not shown) of the bolt hole 11a and a male thread portion (not shown) of the bolt 12 is increased. Along with an increase in fitting length, the two circumferential-direction end portions 14a and 14b are brought closer to each other. This action of bringing the two circumferential-direction end portions closer decreases a circumferential length of an inner peripheral surface 10a of the ring main body 10, which comprises a width dimension of the cut 13 in the circumferential direction. Thus, the ring main body 10 is reduced in diameter.

In this embodiment, the ring main body 10 has a cutout portion 15 that is formed on the side opposite to the cut 13 across a center line C1 of the inner peripheral surface 10a of the ring main body 10. The cutout portion 15 allows promotion of a diameter-reducing action (deformation) for the ring main body 10.

The ring main body 10 has a misalignment preventing part 16 configured to prevent misalignment of a center of gravity CG of the ring main body 10 from the center line C1 of the inner peripheral surface 10a of the ring main body 10. In this embodiment, a center line C2 of an outer peripheral surface 10b of the ring main body 10 is set at a position different from a position of the center line C1 of the inner peripheral surface 10a. Specifically, the misalignment preventing part 16 is achieved with a positional difference between the center line C1 and the center line C2. In this embodiment, a predetermined direction is set so that the center line C2 of the outer peripheral surface 10b is brought closer to a relatively lightweight portion of the ring main body 10 because of, for example, the presence of the bolt holes 11a and 11b or the cut 13. Further, the amount of difference between the center lines C1 and C2 is set to an appropriate magnitude in view of weight balance of the ring main body 10 in the circumferential direction. In this case, the ring main body 10 has a thickness distribution with a relatively large thickness on the side with the bolt holes 11a and 11b and a relatively small thickness on the side (the side with the cutout portion 15 in this case) opposite to the bolt holes 11a and 11b with respect to the center line C1 of the inner peripheral surface 10a.

In a case of a clamping ring 106 without the misalignment preventing part 16, weight balance of a ring main body 110 of the clamping ring 106 has a distribution in which the ring main body 110 is relatively light on a side with bolt holes 111a and 111b with respect to a center line C11 of an inner peripheral surface 110a and relatively heavy on the side opposite to the bolt holes 111a and 111b. Thus, a center of gravity CGI of the clamping ring 106 is misaligned from the center line C11 of the inner peripheral surface 110a of the ring main body 110, with which the center of gravity CG1 should otherwise be aligned, in a radial direction toward the side opposite to the bolt holes 111a and 111b.

Meanwhile, as described above, the clamping ring 6 according to this embodiment further comprises the misalignment preventing part 16 configured to prevent the misalignment of the center of gravity CG of the ring main body 10 from the center line C1 of the inner peripheral surface 10a of the ring main body 10. Under a state in which the inner ring 2 of the bearing unit 1 is fixed to the shaft part S with use of the clamping ring 6 having the configuration described above, the inner peripheral surface 10a of the ring main body 10 is in close contact with the axial-direction extending part 7 of the inner ring 2, and the axial-direction extending part 7 is in close contact with the outer peripheral surface of the shaft part 5. Thus, when the center line of the inner peripheral surface 10a of the ring main body 10 and a center line of an inner peripheral surface of the inner ring 2. in this case, a center line of an inner peripheral surface of the axial-direction extending part 7 are aligned with each other, the center of gravity CG of the clamping ring 6 is aligned with or is extremely close to the center line C1 of the inner peripheral surface 10a of the ring main body 10, that is, a center line C3 of the inner peripheral surface of the inner ring 2. Thus, when the inner ring 2 is mounted over the shaft part 5 as described above, whirling, which may occur during rotation, can be prevented as much as possible to enable achievement of excellent rotation performance.

Further, in this embodiment, the misalignment preventing part 16 is achieved by setting the center line C2 of the outer peripheral surface 10b of the ring main body 10 at a position different from a position of the center line C1 of the inner peripheral surface 10a to thereby provide a difference (distribution) in thickness of the ring main body 10 in the radial direction. At this time, as illustrated in FIG. 4, the center line C2 of the outer peripheral surface 10b is shifted toward the bolt holes 11a and 11b. As a result, the ring main body 10 has a thickness distribution in which the thickness is relatively large on the side with the bolt holes 11a and 11b and is relatively small on the side (side with the cutout portion 15 in this case) that is opposite to the bolt holes 11a and 11b with respect to the center line C1 of the inner peripheral surface 10a. Thus, a lack of weight in a part of the ring main body 10 on the side with the bolt holes 11a and 11b is compensated for by increasing the thickness of the part to thereby enable the center of gravity CG of the clamping ring 6 to be aligned with or be set as close as possible to the center line C1 of the inner peripheral surface 10a of the ring main body 10 and, in turn, the center line C3 of the inner peripheral surface of the inner ring 2. Further, when the center line C2 of the outer peripheral surface 10b is to be shifted in the predetermined direction from the center line C1 of the inner peripheral surface 10a, a process condition is only required to be coordinated at the time when a traditional process such as finishing of the outer peripheral surface 10b is performed. Thus, the number of steps can be prevented from being substantially increased so as to allow production costs to be maintained.

While the first embodiment of the present invention has been described above, the clamping ring and the bearing unit comprising the ring according to the present invention may adopt any modes within the scope of the present invention without being limited to the mode exemplified above.

For example, in the embodiment described above, regarding the misalignment preventing part 16, there has been exemplified a case in which the misalignment preventing part 16 is achieved by setting the center line C2 of the outer peripheral surface 10b of the ring main body 10 at a position different from the position of the center line C1 of the inner peripheral surface 10a. However, it is apparent that the misalignment preventing part 16 may have other configurations.

FIG. 5 is a front view of a clamping ring 21 of one such example (according to a second embodiment of the present invention). As illustrated in FIG. 5, in the clamping ring 21 according to this embodiment, a misalignment preventing part 16 comprises one or a plurality of boles 22 passing through a ring main body 10. In FIG. 5, there is exemplified a case in which a plurality of holes 22 passing through the ring main body 10 in a thickness direction are formed as the misalignment preventing part 16.

In this case, it is desirable that positions of the holes 22 in a circumferential direction, a direction in which the holes 22 pass, an inner-diameter dimension of each of the holes 22, and the number of holes 22 be appropriately set based on weight balance of the ring main body 10 in consideration of bolt boles 11a and 11b, a cut 13, and a cutout portion 15, and additionally, a state of a bolt 12 (weight of the bolt 12, a position of a center of gravity, or weight balance of the bolt 12) mounted in the bolt holes 11a and 11b. In a case of the embodiment illustrated in FIG. 5, the plurality of holes 22 passing through the ring main body 10 in the thickness direction are formed on a side (lower left side in FIG. 5) that is opposite to the bolt holes 11a and 11b with respect to a center line C1 of an inner peripheral surface 10a in an up-and-down direction and is opposite to a head portion 12a of the bolt 12 in a right-and-left direction.

As described above, also when the misalignment preventing part 16 comprises one or a plurality of holes 22 passing through the ring main body 10, the weight balance of the ring main body 10 can be adjusted so as to align a center of gravity CG of the ring main body 10 with the center line C1 of the inner peripheral surface 10a or set he center of gravity CG as close as possible to the center line C1. Thus, for example, when there arises a need for adjustment of the weight balance of the ring main body 10 after the start of production, the center of gravity CG of the clamping ring 21 can easily be aligned with the center line C1 of the inner peripheral surface 10a of the ring main body 10 and, in turn, a center line C3 (see FIG. 2) of an inner peripheral surface of an inner ring 2 by simply adding a hole formation process for the holes 22.

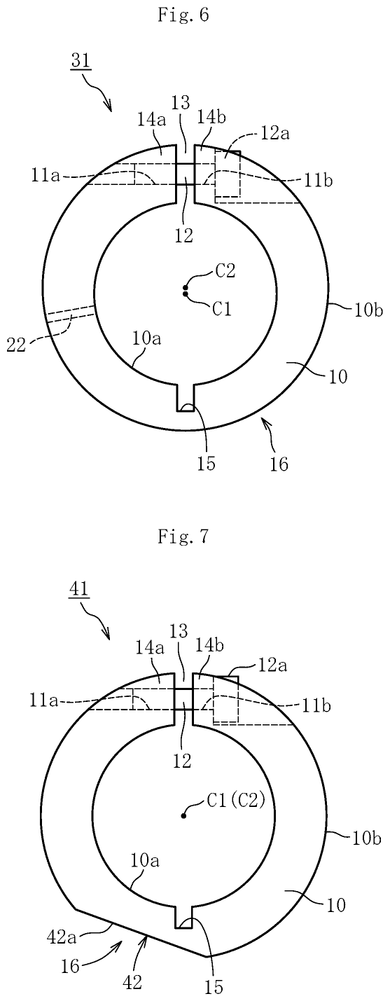

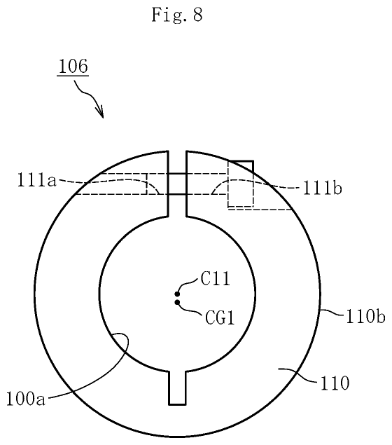

In the embodiments described above, there has been exemplified a case in which the misalignment preventing part 16 is achieved by any one of setting the center line C2 of the outer peripheral surface 10a of the ring main body 10 at a position different from a position of the center line C1 of the inner peripheral surface 10a and forming one or a plurality of holes 22 in the ring main body 10. However, it is apparent that a combination of the means described above may also be used. FIG. 6 is a front view of a clamping ring 31 of one such example (according to a third embodiment of the present invention). As illustrated in FIG. 6, in the clamping ring 31 according to this embodiment, a misalignment preventing part 16 is achieved by setting a center line C2 of an outer peripheral surface 10b of a ring main body 10 at a position different from a position of a center line C1 of an inner peripheral surface 10a and by forming a hole 22 at a predetermined position in the ring main body 10.

Also with the configuration described above, weight balance of the ring main body 10 can be adjusted to align a center of gravity CG of the ring main body 10 with or set the center of gravity CG as close as possible to the center line C1 of the inner peripheral surface 10a of the ring main body 10. Further, when, for example, the positions of the center lines C1 and C2 are to be set intentionally different from each other and the ring main body 10 has a dimensional restriction (for example, a restriction on a maximum outer-diameter dimension of a rotary body at the time of whirling), the use of the combination of the two means enables the adjustment of the weight balance of the ring main body 10) by relatively reducing the amount of difference between the positions of the center lines C1 and C2 and relatively increasing a total volume of the hole 22 (corresponding to a total volume of an internal space of the hole 22, which is a space defined by the hole 22 formed in the ring main body 10). When the ring main body 10 has a restriction in strength, the weight balance of the ring main body 10 can be adjusted by relatively reducing the total volume of the hole 22 and relatively increasing the amount of difference between the positions of the center lines C1 and C2. Thus, for example, when there arises a need for adjustment of the weight balance of the ring main body 10 after the start of production, the center of gravity CG of the clamping ring 31 can easily be aligned with the center line C1 of the inner peripheral surface 10a of the ring main body 10 and, in turn, a center line C3 (see FIG. 2) of an inner peripheral surface of an inner ring 2 by simply adding a hole formation process for the hole 22.

Further, the misalignment preventing part 16 may also have configurations other than those using the positional difference between the center lines C1 and C2 and the hole 22 described above. FIG. 7 is a front view for illustrating a clamping ring 41 of one such example (according to a fourth embodiment of the present invention). As illustrated in FIG. 7, the clamping ring 41 according to this embodiment has a part of an outer peripheral surface 10b of a ring main body 10, which is set inward toward a center line C2 of the outer peripheral surface 10b, to thereby achieve a misalignment preventing part 16.

As in the embodiment illustrated in, for example, FIG. 5, it is desirable that a position of a setback portion 42 in a circumferential direction and the amount of setback be appropriately set based on weight balance of the ring main body 10 in consideration of bolt holes 11a and 11b. a cut 13, and a cutout portion 15 and additionally in consideration of a state of a bolt 12 (weight of the bolt 12, a position of a center of gravity, or weight balance of the bolt 12) mounted into the bolt holes 11a and 11b. In the embodiment illustrated in FIG. 7, the setback portion 42 is formed on a side (lower left side in FIG. 7) that is opposite to the bolt holes 11a and 11b with respect to a center line C1 of an inner peripheral surface 10a in an up-and-down direction and is opposite to a head portion 12a of the bolt 12 in a right-and-left direction.

As described above, also when the misalignment preventing part 16 comprises the setback portion 42 formed by setting inward a part of the outer peripheral surface 10b of the ring main body 10 toward the center line C2 of the outer peripheral surface 10b, the weight balance of the ring main body 10 can be adjusted. In other words, when the setback portion 42 is formed at a predetermined position on the ring main body 10 in the circumferential direction as described above, a center of gravity CG of the ring main body 10 can be aligned with or set closer to the center line C1 of the inner peripheral surface 10a. Further, also when the above-mentioned configuration is used, the center of gravity CG of the clamping ring 41 can easily be aligned with the center line C1 of the inner peripheral surface 10a of the ring main body 10 and, in turn, a center line C3 of an inner peripheral surface of an inner ring 2 by simply adding a predetermined process for the outer peripheral surface 10b of the ring main body 10) after the start of production.

In principle, the setback portion 42 can have any suitable shape. Specifically, in FIG. 7, there is exemplified a case in which the setback portion 42 comprises one flat surface 42a. However, the setback portion 42 may comprise a plurality of flat surfaces (not shown) or one or a plurality of curved surfaces (not shown). Alternatively, the setback portion 42 may comprise a combination of a flat surface and a curved surface (not shown).

It is apparent that the misalignment preventing part 16 may comprise the setback portion 42 described above in combination with the positional difference between the center lines C1 and C2 or with the hole 22 described above.

In the description given above, the axial-direction extending part 7 of the inner ring 2 has been exemplified as having a structure with the plurality of claw portions 9 separated by the slits 8 extending in the axial direction (see FIG. 1 and FIG. 2). However, it is apparent that the axial-direction extending part 7 is not limited to that described above. The axial-direction extending part 7 may have any suitable shape as long as the inner ring 2 can be fixed to the shaft part 5 through intermediation of the axial-direction extending part 7 by a diameter-reducing action for the clamping ring 6 under a state in which the clamping ring 6 is disposed on the outer periphery and the shaft part 5 is inserted along the inner periphery of the inner ring 2.

1. A clamping ring for fixing a part of an inner ring of a bearing through a diameter-reducing action to a shaft part by tightening the part of the inner ring from an outer periphery thereof, the clamping ring comprising:
a ring main body comprising a cut formed in a part in a circumferential direction and a pair of circumferential-direction end portions opposed to each other across the cut;
bolt holes passing through the pair of circumferential-direction end portions, the bolt holes allowing a bolt to be inserted therethrough and then tightened to reduce the ring main body in diameter; and
a misalignment preventing part configured to prevent misalignment of a center of gravity of the ring main body from a center line of an inner peripheral surface of the ring main body.

2. The clamping ring according to claim 1, wherein the misalignment preventing part is achieved by setting a center line of an outer peripheral surface of the ring main body and the center line of the inner peripheral surface at different positions.

3. The clamping ring according to claim 1, wherein the misalignment preventing part comprises one or a plurality of holes passing through the ring main body.

4. The clamping ring according to claim 1, wherein the misalignment preventing part comprises a setback portion formed by setting inward a part of an outer peripheral surface of the ring main body toward a center line of the outer peripheral surface.

5. The clamping ring according to claim 1, wherein the misalignment preventing part is set based on the center of gravity of the ring main body under a state in which the bolt is mounted into the bolt holes.

6. A bearing unit, comprising:
the clamping ring of claim 1;
the bolt to be mounted into the bolt holes of the clamping ring;
the inner ring;
the shaft part to be fitted on an inner periphery of the inner ring; and
an outer ring being rotatable relative to the inner ring.
